(19) United States
(12) Patent Application Publication
(10) Pub. No.: US 2020/0130009 A1
(43) Pub. Date: Apr. 30, 2020

(54) COATING DEVICE

(71) Applicant: HONDA MOTOR CO., LTD., TOKYO (JP)

(72) Inventors: Tomohiko SHIGIHARA, HAGAGUN (JP); Haruya HASHIMOTO, HAGAGUN (JP); Akihiro HONMA, HAGAGUN (JP); Noboru HIRANO, HAGAGUN (JP)

(21) Appl. No.: 16/661,484

(22) Filed: Oct. 23, 2019

(30) Foreign Application Priority Data
Oct. 26, 2018 (JP) 2018-201755

(51) Int. Cl. B05C 5/00; B05C 11/10; B05C 5/02

(52) U.S. Cl. CPC B05C 5/001; B05C 5/0225; B05C 11/1042

(57) ABSTRACT

To provide a coating device which can precisely adjust a discharge amount of high-viscosity material. The coating device coats a high-viscosity material onto a workpiece, and includes a coating gun (2) which discharges the high-viscosity material having flowed in from an inlet port (211) from a discharge port (251); a supply mechanism which pushes out the high-viscosity material to supply from an injection nozzle; and a supply tube which connects the inlet port (211) and supply port. The coating gun (2) includes, at a gun flow channel (3a) from the inlet port (211) until the discharge port (251), a gear pump (31) and needle valve (26) as a discharge amount adjustment mechanism which adjusts the discharge amount of the high-viscosity material from the discharge port (251).

This application is based on and claims the benefit of priority from Japanese Patent Application No. 2018-201755, filed on 26 Oct. 2018, the content of which is incorporated herein by reference.

### BACKGROUND OF THE INVENTION

### Field of the Invention

The present invention relates to a coating device. In more detail, it relates to a coating device which coats a high-viscosity material at higher pressure than atmospheric pressure and higher temperature than atmospheric temperature.

### Related Art

International Unexamined Patent Application No. 2019/065301 by the inventors of the present disclosure illustrates technology which joins a pair of resin members by a molten thermoplastic elastomer. With the joining method of International Unexamined Patent Application No. 2019/065301, the pair of resin members are joined by melting a part of a joining surface of both resin members by the heat of the molten elastomer, and further solidifying this molten portion. In addition, in the case of joining the resin members using the joining method of International Unexamined Patent Application No. 2019/065301, it has been considered to coat the high temperature elastomer which is a high-viscosity material on the joining surface of resin members using a discharge apparatus such as that illustrated in Cited Japanese Unexamined Patent Application, Publication No. 2003-38999, for example.

The discharge apparatus of Japanese Unexamined Patent Application, Publication No. 2003-38999 includes: a cartridge which stores high-viscosity material; a drive unit which imparts a pressing force in the cartridge to push out the high-viscosity material from the outlet of this cartridge; a tube connected to the outlet of the cartridge and delivering the pushed out the high-viscosity material; and a dispenser connected to this tube. The dispenser is provided with a discharge port for high-viscosity material, a needle valve provided to this discharge port, and a trigger which causes this needle valve to advance or retreat. An operator causes the needle valve to advance or retreat by manipulating the trigger to control the ON/OFF of discharge of the high-viscosity material.

### SUMMARY OF THE INVENTION

However, in the case of employing the joining method of International Unexamined Patent Application No. 2019/065301 to join resin members, precisely adjusting the discharge amount of high-viscosity material has been desired. However, with the discharge apparatus shown in Japanese Unexamined Patent Application, Publication No. 2003-38999, since the high-viscosity material is compressed by the drive unit provided at a position distanced from the discharge port, and discharge is controlled by ON/OFF with the needle valve provided to the discharge port, it has not been possible to precisely adjust the discharge amount. In the flow channel on the downstream side from the drive unit, since the high-viscosity material flows while being compressed, it is not possible to adjust the discharge amount so as to linearly change the operating amount by simply the needle valve.

The present invention has an object of providing a coating device which can precisely adjust the discharge amount of high-viscosity material at higher pressure than atmospheric pressure and higher temperature than atmospheric temperature.

A coating device (for example, the coating device 1 described later) according to a first aspect of the present invention is for coating a high-viscosity material onto a coating target (for example, the workpieces 92, 93 described later), and includes: a coating gun (for example, the coating gun 2 described later) which discharges from a discharge port (for example, the discharge port 251 described later) the high-viscosity material having flowed in from an inlet port (for example, the inlet port 211 described later); a high-viscosity material supply mechanism (for example, the supply mechanism 5 described later) which pushes out the high-viscosity material to supply from a supply port (for example, the injection nozzle 53a described later); and a supply tube (for example, the supply tube 6 described later) which connects the inlet port and the supply port, in which the coating gun includes, in a gun flow channel (for example, the gun flow channel 3a described later) from the inlet port until the discharge port, a discharge amount adjustment mechanism (for example, the gear pump 31, drive motor 35, needle valve 26, actuator 28, etc. described later) which adjusts a discharge amount of the high-viscosity material from the discharge port.

According to a second aspect of the present invention, in this case, it is preferable for the discharge amount adjustment mechanism to include a gear pump (for example, the gear pump 31 described later) provided in the gun flow channel, and for the coating gun to further include a heat source (for example, the heater 29 described later) which is provided in a vicinity of the gear pump and heats the high viscosity material in the gear pump or in the gun flow channel.

According to a third aspect of the present invention, in this case, it is preferable for the coating device to further include a robot (for example, the coating robot 7 described later) which supports the coating gun at a leading end part thereof, and controls position and posture of the coating gun, and for the robot to scan the coating gun at a linear velocity of at least 200 mm/sec, while discharging the high-viscosity material from the discharge port.

According to a fourth aspect of the present invention, in this case, it is preferable for the high-viscosity material to be a thermoplastic resin.

The coating device according to the first aspect of the present invention includes the high-viscosity material supply mechanism which pushes out the high-viscosity material; the coating gun to which the discharge port is provided; and the supply tube which connects the supply port of the high-viscosity material supply mechanism and the inlet port of the coating gun. In particular, with the coating device according to the present invention, the coating gun includes the discharge amount adjustment mechanism which adjusts the discharge amount of high-viscosity material from the discharge port, in the gun flow channel from the inlet port leading to the discharge port. In this way, the coating device of the present invention pushes out the high-viscosity material by way of the high-viscosity material supply mechanism to the coating gun via the supply tube, and further, adjusts the discharge amount of high-viscosity material discharged from the discharge port by way of the discharge amount adjustment mechanism provided on the downstream side from this supply tube, and in the vicinity of the discharge port of the coating gun. It is thereby possible to precisely adjust the discharge amount from the discharge port, even with a high-viscosity material which is higher pressure than atmospheric pressure and higher temperature than atmospheric temperature.

In the coating device according to the second aspect of the present invention, the discharge amount adjustment mechanism includes the gear pump provided in the gun flow channel, and the coating gun includes a heat source which is provided in the vicinity of this gear pump and heats the high-viscosity material in this gear pump or gun flow channel. Since it is thereby possible to maintain the temperature of the high-viscosity material fed in the gear pump at the preferred temperature, it is possible to precisely adjust the discharge amount from the discharge port.

The coating device according to the third aspect of the present invention includes a robot which supports the coating gun at the leading end part, and controls the position and posture of this coating gun. In the aforementioned way, with the coating device of the present invention, by independently establishing the high-viscosity material supply mechanism which pushes out the high-viscosity material and the discharge amount adjustment mechanism which adjusts the discharge amount, and thereamong, providing the discharge amount adjustment mechanism to the coating gun, the coating gun is reduced in size; therefore, it becomes possible to control the position and posture of this coating gun by the robot. Consequently, according to the coating device according to the present invention, it is possible to linearly coat the high-viscosity material onto a coating target, and fill the high-viscosity material between narrow gaps of the coating target. In addition, in the coating device according to the present invention, the robot scans the coating gun at a linear velocity of at least 200 mm/sec, while discharging the high-viscosity material from the discharge port. It is thereby possible to finish the coating process using the coating gun, before the high-viscosity material discharged from the coating gun cools.

The coating device according to the fourth aspect of the present invention uses a thermoplastic resin as the high-viscosity material. It is thereby possible to coat the thermoplastic resin from the coating gun onto a coating target, and weld the coating target with this thermoplastic resin as the heat source.

### BRIEF DESCRIPTION OF THE DRAWINGS

FIG. 1 is a view showing the configuration of a coating device according to an embodiment of the present invention;

FIG. 2 is a perspective view of a coating gun;

FIG. 3 is a partial cross-sectional view of a coating gun;

FIG. 4 is a cross-sectional view of a gear pump, which is along the line IV-IV in FIG. 3;

FIG. 5 is a cross-sectional view of a portion of a gun body in which a heater is provided, which is a cross-sectional view along the line V-V in FIG. 3;

FIG. 6 is a cross-sectional view of a resin joint produced by a joining method according to the present embodiment; and

FIG. 7 is a view for explaining a specific sequence of a joining method.

### DETAILED DESCRIPTION OF THE INVENTION

Hereinafter, the configuration of a coating device 1 according to one embodiment of the present invention will be explained in detail while referencing the drawings.

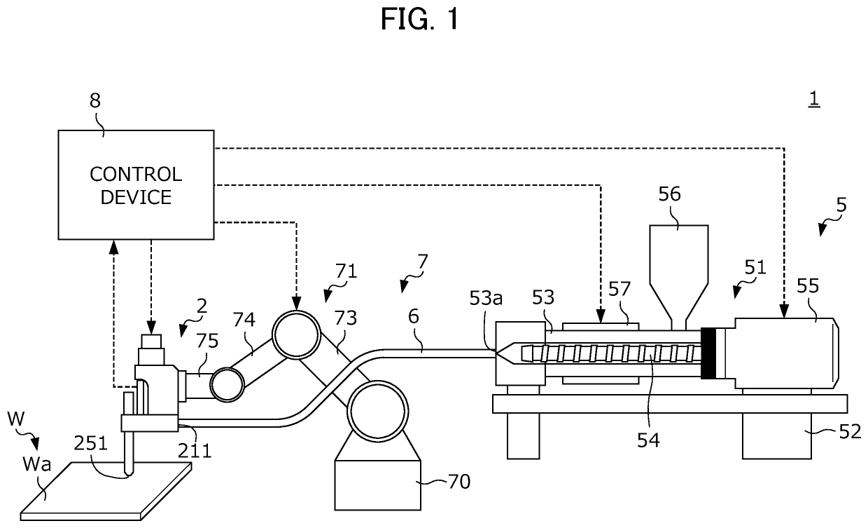

FIG. 1 is a view showing the configuration of the coating device 1. The coating device 1 includes: a supply mechanism 5 which supplies a high-viscosity material from a injection nozzle 53a; a coating gun 2 which discharges the high-viscosity material flowed in from an inlet port 211 from a discharge port 251; a supply tube 6 which connects the injection nozzle 53a of the supply mechanism 5 and the inlet port 211 of the coating gun 2; a coating robot 7 which supports the coating gun 2; a control device 8 which controls this supply mechanism 5, coating gun 2 and coating robot 7, and coats a high-viscosity material of higher pressure than atmospheric pressure and higher temperature than atmospheric temperature onto a workpiece W, which is a coating target. Hereinafter, a case of using a thermoplastic resin as the high-viscosity material which coats a workpiece W by way of the coating device 1 will be explained; however, the present invention is not to be limited thereto. As the high-viscosity material, for example, a general purpose resin such as polypropylene, elastomer, ABS and polystyrene, a sealer or the like can be used.

The supply mechanism 5 includes a supply mechanism body 51 and a stand 52 which supports this supply mechanism body 51. The supply mechanism body 51 includes: a tubular cylinder 53 in which an injection nozzle 53a is formed at a leading end side thereof; a screw 54 which is rotatably supported inside this cylinder 53; a motor 55 which is provided to a base end side of the cylinder 53 and causes the screw 54 to rotate inside of the cylinder 53; a hopper 56 which supplies the high-viscosity material into the cylinder 53; and a heater 57 which heats the high-viscosity material inside the cylinder 53.

The supply mechanism 5 heats by the heater 57 the high-viscosity material inside the cylinder 53 which was supplied from the hopper 56, and compresses the high-viscosity material inside the cylinder 53 along the axial direction, by rotating the screw 54 by the motor 55. The supply mechanism 5 pushes out to supply the high-viscosity material which reached higher pressure than atmospheric pressure and higher temperature than atmospheric temperature within the cylinder 53, from the injection nozzle 53a on the leading end side in the axial direction of the cylinder 53. The control device 8 controls the heater 57 and motor 55, so that the temperature of the high-viscosity material inside the cylinder 53 is maintained at a target temperature set to be higher than atmospheric temperature, and the pressure inside the cylinder 53 is maintained at the target pressure set to be higher than atmospheric pressure.

The supply tube 6 is a tube member which connects the injection nozzle 53a of the supply mechanism 5 and the inlet port 211 of the coating gun 2, and leads the high-viscosity material pushed out from the injection nozzle 53a to the inlet port 211. As this supply tube 6, for example, a flexible heat-resistant hose can be used which is equipped with a heating function to heat the high-viscosity material flowing inside of an inner tube and a pressure-resisting function to preserve this inner tube. More specifically, as the supply tube 6, a tube can be used which is equipped with an inner tube in which high-viscosity material flows; a metallic mesh-like pressure-resistant layer which covers the outer circumferential face of the inner tube; an insulating layer which covers the outer circumferential face of this pressure-resistant layer; a heat-generating layer which covers the outer circumferential face of this insulating layer; a heat-retaining layer which covers the outer circumferential face of this heat-generating layer; and a cladding layer which covers the outer circumferential face of the heat-retaining layer.

The coating robot 7 includes a robot body 70 mounted to the floor, and an articulated arm 71 which is pivotally supported by this robot body 70. The articulated arm 71 includes: a first arm part 73 having a base end side thereof pivotally supported by the robot body 70; a second arm part 74 having a base end side thereof pivotally supported by the first arm part 73; and a third arm part 75 having a base end side thereof pivotally supported by the second arm part 74, and having an arm mounting part 39 described later of the coating gun 2 mounted to the leading end side thereof. The control device 8 drives the respective arm parts 73 to 75 by driving a plurality of motors provided to the robot body 70 and articulated arm 71, thereby controlling the position and attitude of the coating gun 2 mounted to the third arm part 75, and causing the discharge port 251 of the coating gun 2 to move to the coating surface Wa of the workpiece W. . Using a flexible tube member as the supply pipe 6 as mentioned above, it is possible to control the position and attitude of the coating gun 2 by the coating robot 7, while supplying the high-viscosity material at high pressure and high temperature to the coating gun 2 from the supply mechanism body 51 placed on the stand 52.

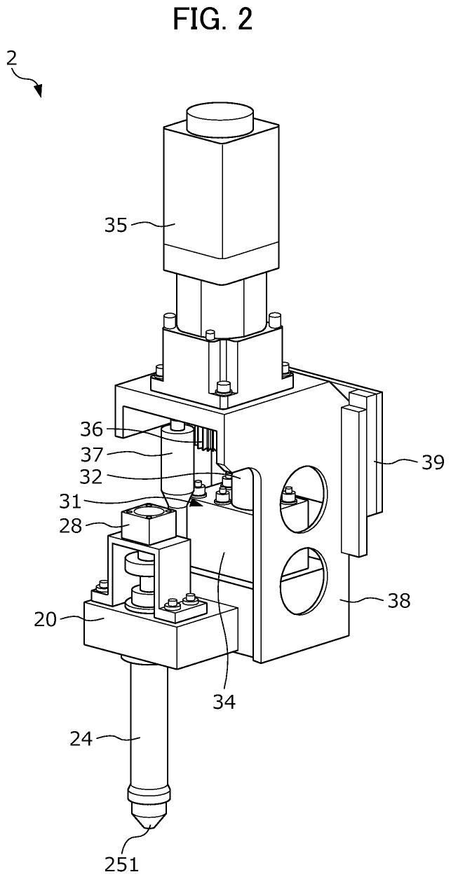

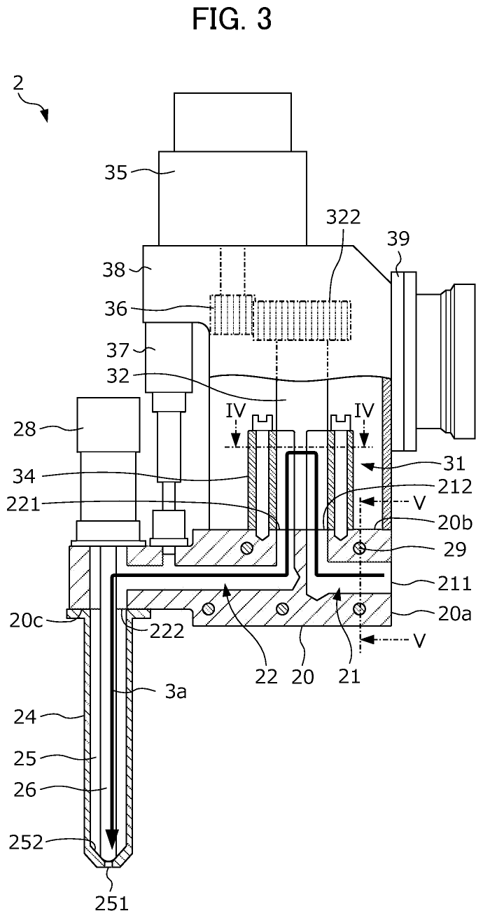

FIG. 2 is a perspective view of the coating gun 2. FIG. 3 is a partial cross-sectional view of the coating gun 2.

The coating gun 2 includes: a gun body 20 in which a flow channel of the high-viscosity material is formed inside; a cylindrical discharge nozzle 24 mounted to this gun body 20; a rod-like needle valve 26 (refer to FIG. 3) provided to a nozzle flow channel 25 inside of this discharge nozzle 24; an actuator 28 which advances and retreats this needle valve 26; a heater 29 provided to the gun body 20; a gear pump 31 which is mounted to the gun body 20; a drive motor 35 which drives this gear pump 31; a pressure sensor 37 which is mounted to the gun body 20; a bracket 38 which supports the gun body 20 and drive motor 35; and an arm mounting part 39 provided to this bracket 38.

The gun body 20 is a block shape, in which a first flow channel 21 and second flow channel 22 through which the high-viscosity material flows are formed inside as shown in FIG. 3. The first flow channel 21 leads from the inlet port 211 for high-viscosity material formed in a lateral face 20a on the base end side of the gun body 20 to a first connection opening 212 formed in a pump mounting face 20b on a base end side of the upper surface of the gun body 20. The second flow channel 22 leads from a second connection opening 221 formed in the vicinity of the first connection opening 212 in the pump mounting face 20b of the gun body 20 to a third connection opening 222 formed in the nozzle mounting face 20c on the leading end side of the lower surface of the gun body 20.

The discharge nozzle 24 is a cylindrical shape in which the nozzle flow channel 25 is formed inside thereof as shown in FIG. 3. The leading end side of the nozzle flow channel 25 is a discharge port 251 which discharges the high viscosity material. The discharge nozzle 24 is fixed to the nozzle mounting face 20c of the gun body 20, so that the nozzle flow channel 25 is connected to the third connection opening 222. By fixing the discharge nozzle 24 to the gun body 20 in this way, the flow channel of high-viscosity material leading from the second connection opening 221 to the discharge port 251 is formed.

It should be noted that, in the present embodiment, a case is explained of fixing the discharge nozzle 24 to the gun body 20, so that the discharge nozzle 24 becomes parallel to the vertical direction and the discharge nozzle 251 is faced downwards, when setting the posture of the coating gun 2 to a base posture such as that shown in FIG. 2; however, the present invention is not limited thereto. The discharge nozzle may be fixed to the gun body 20 so as to become parallel to the horizontal direction, for example, in the base posture of the coating gun.

The needle valve 26 is provided to freely advance/retreat along the axis line direction of the discharge nozzle 24, inside of the nozzle flow channel 25 as shown in FIG. 3. By advancing or retreating the needle valve 26 along the axis line direction of the discharge nozzle 24, the actuator 28 seats the needle valve 26 on a valve seat 252 formed in the vicinity of the discharge port 251, or unseats the needle valve 26 from this valve seat 252. When the needle valve 26 is seated at the valve seat 252, the nozzle flow channel 25 is closed, and the discharge amount of the high-viscosity material from the discharge port 251 becomes 0. When the needle valve 26 is unseated from the valve seat 252, the nozzle flow channel 25 is open, and the high-viscosity material is discharged from the discharge port 251. An air cylinder, solenoid or the like is used as this actuator 28.

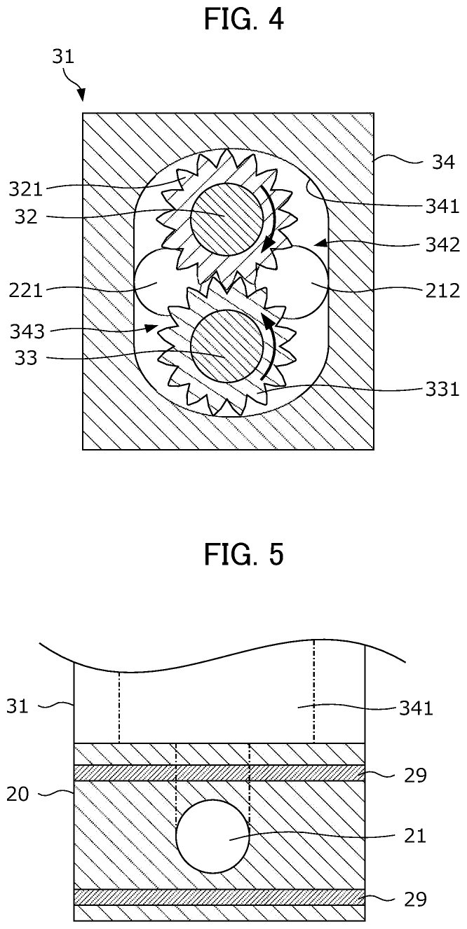

FIG. 4 is a cross-sectional view of the gear pump 31, which is a cross-sectional view along the line IV-IV in FIG. 3. The gear pump 31 includes a pump body 34 fixed to the pump mounting face 20b of the gun body 20, and two rod-shaped pump shafts 32, 33 which are rotatably supported by this pump body 34. Inside of the pump body 34, a pump chamber 341 is formed which accommodates the leading end part of the two pump shafts 32, 33, and connects the first connection opening 212 and second connection opening 221 formed in the pump mounting face 20b.

A first pump gear 321 is formed at the leading end part of the first pump shaft 32. In addition, a second pump gear 331 which meshes with the first pump gear 321 is formed at the leading end part of the second pump shaft 33. In a state accommodating the lead end parts of these pump shafts 32, 33 in the pump chamber 341, the pump chamber 341 is demarcated by the two pump gears 321, 331 into a first sub-pump chamber 341 which is in communication with the first connection opening 212, and a second sub-pump chamber 343 which is in communication with the second connection opening 221.

In the above such gear pump 31, when rotating the first pump shaft 32 clockwise in FIG. 4, the second pump gear 331 meshing with the first pump gear 321 rotates counter-clockwise, and the high-viscosity material flowing into the first sub-pump chamber 342 from the first flow channel 21 via the first connection opening 212 is transported to the second sub-pump chamber 343 by these pump gears 321, 331, and transported to the second flow channel 22 via the second connection opening 221. Consequently, the transport amount per unit time of high viscosity material from the first connection opening 212 to the second connection opening 221 by the gear pump 31, i.e. discharge amount per unit time of high viscosity material from the discharge port 251, and the discharge pressure, which is the pressure of high viscosity material at the second flow channel 22 can be adjusted by the rotation speed of the first pump shaft 32.

The drive motor 35 is mounted to the bracket 38 so that the drive shaft thereof is parallel to the first pump shaft 32. A drive gear 36 which meshes with the shaft gear 322 provided to the base end part of the first pump shaft 32 is provided to the drive shaft of the drive motor 35. Therefore, by using the drive motor 35, it is possible to cause the first pump shaft 32 to rotate. Consequently, the rotation speed of the first pump shaft 32, i.e. discharge amount and discharge pressure of high-viscosity material, can be adjusted by the drive motor 35. It should be noted that, according to the gear pump 31 according to the present embodiment, it is possible to adjust the discharge amount to between 0 and 25 cc/sec, for example, by adjusting the rotation speed of the first pump shaft 32.

FIG. 5 is a cross-sectional view of a portion of the gun body 20 in which the heater 29 is provided, which is a cross-sectional view along the line V-V in FIG. 3. The heater 29 is a heating wire, for example, and is embedded inside of the gun body 20 in the vicinity of the gear pump 31, first flow channel 21 and second flow channel 22. The heater 29 generates heat when electrical current flows, thereby heating the high-viscosity material within the pump chamber 341, first flow channel 21 and second flow channel 22. The electrical current flowing through the heater 29 is controlled by a controller (not illustrated) so that the temperature of the high-viscosity material within this pump chamber 341, first flow channel 21 and second flow channel 22 is maintained at a predetermined set temperature (for example, 250 to 300° C.)

In the coating gun 2, the gun flow channel 3a, which is a flow channel of the high-viscosity material from the inlet port 211 until the discharge port 251, is configured in order from the upstream side to the downstream side by the first flow channel 21 formed in the gun body 20, the pump chamber 341 of the gear pump 31, the second flow channel 22 formed in the gun body 20, and the nozzle flow channel 25 formed in the discharge nozzle 24.

In addition, in this coating gun 2, the discharge amount adjustment mechanism for adjusting the discharge amount of high-viscosity material from the discharge port 251 is configured by the gear pump 31 provided to the gun flow channel 3a, the drive motor 35 driving this gear pump 31, the needle valve 26 provided in the gun flow channel 3a on the downstream side from the gear pump 31, and the actuator 28 which advances and retreats this needle valve 26.

The pressure sensor 37 sends a detection signal according to the pressure in the gun flow channel 3a on the downstream side from the gear pump 31 and the upstream side from the needle valve 26, more specifically, inside the second flow channel 22, to the control device 8.

The control device 8, in the case of discharging high-viscosity material from the discharge port 251, adjusts the rotation speed of the pump shaft 32 based on the detection signal sent from the pressure sensor 37, so as to unseat the needle valve 26 from the valve seat 252 using the actuator 28, and open the nozzle flow channel 25, and the high-viscosity material of a predetermined target discharge amount is discharged from the discharge port 251. In addition, the control device 8, in the case of stopping the discharge of high viscosity material from the discharge port 251, seats the needle valve 26 against the valve seat 252 using the actuator 28 to close the nozzle flow channel 25.

According to the coating device 1 of the present embodiment, the following effects are exerted.

(1) The coating device includes the supply mechanism 5 which pushes out the high-viscosity material; the coating gun 2 in which the inlet port 211 and discharge port 251 are provided, and the supply tube 6 which connects the injection nozzle 53a of the supply mechanism 5 and the inlet port 211 of the coating gun 2. Particularly with the coating device 1 according to the present embodiment, the coating gun 2 includes the gear pump 31 and needle valve 26 as a discharge amount adjustment mechanism that adjusts the discharge amount of high-viscosity material from the discharge port 251 in the gun flow channel 3a leading to the discharge port 25 from the inlet port 211. In this way, the coating device 1 pushes out the high-viscosity material by the supply mechanism 5 to the coating gun 2 via the supply tube 6, and adjusts the discharge amount of the high-viscosity material discharged from the discharge port 251 by the discharge amount adjustment mechanism provided on the downstream side from this supply tube 6 and in the vicinity of the discharge port 251 of the coating gun 2. It is thereby possible to precisely adjust the discharge amount from the discharge port 251, even with high-viscosity material which is higher pressure than atmospheric pressure and higher temperature than atmospheric temperature.

(2) In the coating device 1, the discharge amount adjustment mechanism includes the gear pump 31 which is provided to the gun flow channel 3a. In addition, the coating gun 2 includes the heater 29 which is provided in the vicinity of this gear pump 31 and heats the high viscosity material in this gear pump 31 or gun flow channel 3a. Since it is thereby possible to maintain the temperature of high-viscosity material fed by the gear pump 31 at a preferred temperature, the discharge amount from the discharge port 251 can be precisely adjusted.

(3) In the coating device 1, the discharge amount adjustment mechanism includes the gear pump 31 provided in the gun flow channel 3a, the drive motor 35 which drives this gear pump 31, and the needle valve 26 which is provided in the gun flow channel 3a more to the downstream side than the gear pump 31. With the coating device 1, it is thereby possible to perform ON/OFF control of discharge of the high-viscosity material by way of the needle valve 26, and thus possible to adjust the discharge amount of high-viscosity material by the gear pump 31 so as to become linear with respect to the manipulation amount of the gear pump 31 (i.e. revolution speed of the pump shaft 32).

(4) The coating device 1 includes the coating robot 7 which supports the coating gun 2 at a leading end part, as well as controlling the position and posture of this coating gun 2. In the aforementioned way, with the coating device 1, by independently establishing the supply mechanism 5 which pushes out the high-viscosity material and the discharge amount adjustment mechanism which adjusts the discharge amount, and thereamong, providing the discharge amount adjustment mechanism to the coating gun 2, the coating gun 2 is reduced in size; therefore, it becomes possible to control the position and posture of this coating gun 2 by the coating robot 7. Consequently, according to the coating device 1, it is possible to linearly coat the high-viscosity material onto a workpiece W, and fill the high-viscosity material between narrow gaps of the workpiece W.

Next, a joining method for joining a pair of resin joining targets using the above such coating device 1 will be explained while referencing the drawings.

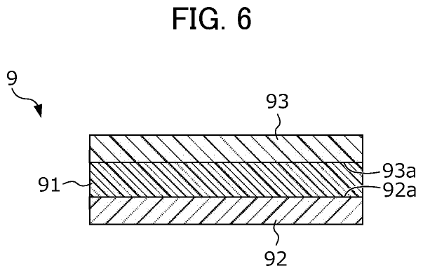

FIG. 6 is a cross-sectional view of a resin joint 9 produced by the joining method according the present embodiment. The resin joint 9 is configured by a first workpiece 92 and second workpiece 93 made of resin which are joined via an elastomer 91. It should be noted that the resin joint 9 can be applied in joints of various applications, and can be established in various forms according to the application thereof.

The material of the first workpiece 92 is not particularly limited; however, from the viewpoint of raising the shock resistance, for example, the resin material is at last either one of polypropylene and polyethylene, and fiber reinforced resin in which the reinforcing fibers are talc fibers can be used.

The material of the second workpiece 93 is not particularly limited; however, from the viewpoint of raising strength, for example, the resin material is at least either one of polypropylene and polyethylene, and a fiber reinforced resin in which the reinforcing fibers are glass fibers can be used. The linear expansion coefficient of the second workpiece 93 has a different magnitude than the linear expansion coefficient of the first workpiece 92. In addition, the second workpiece 93 hardly generates thermal distortion compared to the first workpiece 92.

The elastomer 91 is interposed between a first joining surface 92a of the first workpiece 92 and a second joining surface 93a of the second workpiece 93. In addition, the elastomer 91 is thermoplastic, and consists of a composition close to the resin materials of the first workpiece 92 and second workpeice 93. The hardness of the elastomer 91 is not particularly limited; however, it is no more than Shore A hardness 70, for example. In the case of the resin materials of the first workpiece 92 and second workpiece 93 being at least either one of polypropylene and polyethylene, the elastomer 91 is preferably an olefin-based elastomer. By respectively setting the materials of elastomer 91, first workpiece 92 and second workpiece 93 in this way, it is possible to join the first joining surface 92a and second joining surface 93a with very high strength via the elastomer 91.

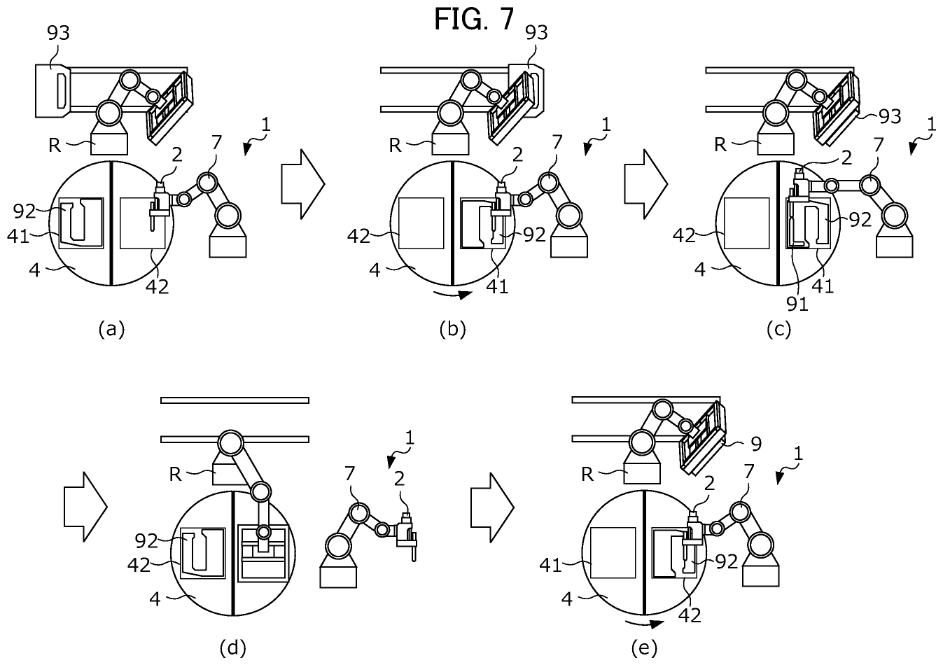

FIG. 7 is a drawing for explaining a specific sequence of the joining method for joining the pair of workpieces 92, 93 using a conveying robot R, turn table 4, and coating device 1 to produce the resin joint 9. A plurality of jigs (for example, two) 41, 42 which position the first workpiece 92 is provided to the turn table 4. The joining method according to the present embodiment is configured by a positioning step (a), reversing step (b), coating step (c), pressure-bonding step (d) and delivering step (e), as shown in FIG. 7.

In the positioning step, the first workpiece 92 which was molded in advance is placed in the first jig 41 of the turn table 4 using a conveying device (not illustrated) to position the first workpiece 92 (refer to (a) in FIG. 7).

In the reversing step, the first workpiece 92 that was positioned by the first jig 41 is made to oppose the coating robot 7 of the coating device 1 by causing the turn table 4 to rotate (refer to (b) in FIG. 7).

In the coating step, after making the coating gun 2 approach using the coating robot 7 to the first joining surface 92a of the first workpiece 92 positioned by the first jig 41, the elastomer 91 is coated on the first joining surface 92a by scanning the coating gun 2 at a predetermined linear velocity (for example, at least 200 mm/sec) along the first joining surface 92a, while discharging the elastomer 91 which has been melted from the coating gun 2 (refer to (c) in FIG. 7). It should be noted that, while coating the elastomer 91 by the coating device 1, it is preferable for the conveying robot R to grip the second workpiece 93 and standby in the vicinity of the first workpiece 92 in preparation of the subsequent pressure-bonding step.

In the pressure-bonding step, the second workpiece 93 molded in advance is pressure bonded to the first workpiece 92 to which the elastomer 91 was coated using the conveying robot R, and cools the workpieces 92, 93 by a cooling device (not illustrated) (refer to (d) in FIG. 7). The first joining surface 92a of the first workpiece 92 and the second joining surface 93a of the second workpeice 93 melted by the heat of the elastomer 91 solidify, whereby the resin joint 9 is produced. It should be noted that, while pressure bonding the workpiece 92, 93 by way of the conveying robot R, it is preferable for a conveying device (not illustrated) to place the first workpiece 92 molded in advance in the second jig 42 of the turn table 4, in preparation for the subsequent production step of the resin joint 9.

In the delivering step, the resin joint 9 produced in the pressure-bonding step is removed from the first jig 41 using the conveying robot R, and the turn table 4 is rotated, whereby the first workpiece 92 positioned by the second jig 42 is made to face the coating robot 7 of the coating device 1 (refer to (e) in FIG. 7). By repeatedly executing the coating step, pressure-bonding step and delivering step thereafter, it is possible to produce a plurality of resin joints 9.

According to the joining method of the present embodiment, the following effects are exerted.

(5) In the coating device 1, the coating robot 7 scans the coating gun 2 at a linear velocity of at least 200 mm/sec, while discharging the elastomer 91 melted from the discharge port 251. Since it is thereby possible to quickly finish the coating step prior to the elastomer 91 discharged from the coating gun 2 to the first workpiece 92 cooling, it is possible to melt the second joining surface 93a of the second workpiece 93 with the high-temperature elastomer 91, and strongly join the first workpiece 92 and second workpiece 93 in the subsequent pressure-bonding step.

(6) With the coating device 1, the elastomer 91 which is a thermoplastic resin is used as the high-viscosity material. It is thereby possible to coat the elastomer 91 which was melted from the coating gun 2 onto the workpieces 92, 93, and adhere the workpieces 92, 93 with this high-temperature elastomer 91 as the heat source.

(7) In the joining method according to the present embodiment, the first workpiece 92 is positioned, and further, high-temperature elastomer 91 is discharged from the discharge port 251, and coated onto the first joining surface 92a of this positioned first workpiece 92, and the second workpiece 93 is pressure-bonded to the first workpiece 92 on which the elastomer 91 was coated. It is thereby possible to pressure-bond the workpieces 92, 93 made of resin with the melted elastomer 91 as the heat source. While it is necessary to conduct pre-processing on the workpieces 92, 93 such as primer treatment or plasma treatment for improving the hydrophilicity in the case of joining the workpieces 92, 93 by an adhesive, it is possible to join these workpieces 92, 93 without conducting such pre-processing according to the joining method of the present embodiment.

Although an embodiment of the present invention has been explained above, the present invention is not to be limited thereto. The configurations of detailed parts may be modified as appropriate within the scope of the aim of the present invention. Although the above-mentioned embodiment explains a case of joining the workpieces 92, 93 using a turn table 4, the present invention is not to be limited thereto.

What is claimed is:

1. A coating device for coating a high viscosity material onto a coating target, the coating device comprising:
a coating gun which discharges from a discharge port the high-viscosity material having flowed in from an inlet port;
a high-viscosity material supply mechanism which pushes out the high-viscosity material to supply from a supply port; and
a supply tube which connects the inlet port and the supply port,
wherein the coating gun includes, in a gun flow channel from the inlet port until the discharge port, a discharge amount adjustment mechanism which adjusts a discharge amount of the high-viscosity material from the discharge port.

2. The coating device according to claim 1, wherein the discharge amount adjustment mechanism includes a gear pump provided in the gun flow channel, and
wherein the coating gun further includes a heat source which is provided in a vicinity of the gear pump and heats the high viscosity material in the gear pump or in the gun flow channel.

3. The coating device according to claim 1, further comprising a robot which supports the coating gun at a leading end part thereof, and controls position and posture of the coating gun,
wherein the robot scans the coating gun at a linear velocity of at least 200 mm/sec, while discharging the high-viscosity material from the discharge port.

4. The coating device according to claim 2, further comprising a robot which supports the coating gun at a leading end part thereof, and controls position and posture of the coating gun,
wherein the robot scans the coating gun at a linear velocity of at least 200 mm/sec, while discharging the high-viscosity material from the discharge port.

5. A coating device according to claim 1, wherein the high-viscosity material is a thermoplastic resin.

6. A coating device according to claim 2, wherein the high-viscosity material is a thermoplastic resin.

7. A coating device according to claim 3, wherein the high-viscosity material is a thermoplastic resin.

8. A coating device according to claim 4, wherein the high-viscosity material is a thermoplastic resin.
